(19) United States
(12) Patent Application Publication
(10) Pub. No.: US 2015/0379131 A1
(43) Pub. Date: Dec. 31, 2015

(54) SYSTEMS AND METHODS FOR DETERMINING CONNECTION STRENGTH IN A RELATIONSHIP MANAGEMENT SYSTEM

(71) Applicant: salesforce.com, inc., San Francisco, CA (US)

(72) Inventors: Maxim Gurevich, Cupertino, CA (US); Gary Lerhaupt, San Francisco, CA (US); Kunal Punera, San Francisco, CA (US)

(21) Appl. No.: 14/315,823

(22) Filed: Jun. 26, 2014

(51) Int. Cl. G06F 17/30

(52) U.S. Cl. CPC G06F 17/30867; G06F 17/3053

(57) ABSTRACT

A method and apparatus for determining connection strength for users of a relationship management system is described. The method may include receiving a request from a first user of a relationship management system user for a connection strength score associated with a relationship management system account. Furthermore, the method may include determining connection strength scores between each of the plurality of contacts in the account and the organization based on communications exchanged between each of the plurality of contacts with users of the relationship management system. The method may also include selecting a subset of contacts from the account based on the determined connection strength scores, and presenting the selected subset of contacts from the account to the first relationship management system user.

### TECHNICAL FIELD

Embodiments of the invention relate to the field of electronic communication management, and more particularly, to determining connection strength for users of a relationship management system.

### BACKGROUND

Customer relationship management (CRM) systems provide tools for managing interactions with customers. The interactions may include the flow of communications between a single user with a customer, such as the exchange of telephone calls, emails, in-person meetings, as well as other types of interactions. The interactions may also include the flow of communications of other users, such as multiple employees from a company, office, school, etc., interacting with a customer. CRM solutions collect a centralized record of these interactions. From the record of the interactions, CRM systems attempt to summarize and track the interactions in a meaningful way.

Sometimes a user of a CRM system will desire to connect with a customer, company, etc. When the user has not previously connected with the customer, company, etc., the user may reach out to other users of the CRM system, as well as non-CRM users, for an introduction. However, the quality of the introduction is limited to those people that respond and are willing to make the introduction. Furthermore, there is not guarantee that the person making the introduction is the best person with the user's organization.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a block diagram of exemplary system architecture for determining connection strength determination in a relationship management system in accordance with an embodiment of the invention;

FIG. 2 is a block diagram of one embodiment of a relationship management server and a relationship management application run on a user system;

FIG. 3 is a flow diagram of one embodiment of a method for gathering connection strength data in a shared contacts space of a relationship management system;

FIG. 4 is a flow diagram of one embodiment of a method for determining contacts within an account in a relationship management system that are closely connected to an organization;

FIG. 5 is a flow diagram of one embodiment of a method for determining which organizational users are closely connected with a subset of closely connected account contacts;

FIG. 6 illustrates an exemplary user interface for presenting connection strength determinations between an identified contact and users of a relationship management system;

FIG. 7 illustrates an exemplary user interface for presenting connection strength determinations between an account and users of a relationship management system; and

FIG. 8 is one embodiment of a computer system that may be used in accordance with an embodiment of the invention.

### DETAILED DESCRIPTION

In the following description, numerous details are set forth. It will be apparent, however, to one of ordinary skill in the art having the benefit of this disclosure, that the present invention may be practiced without these specific details. In some instances, well-known structures and devices are shown in block diagram form, rather than in detail, in order to avoid obscuring the present invention.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving”, “determining”, “selecting”, “presenting”, “generating”, “collecting”, “combining”, “performing”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

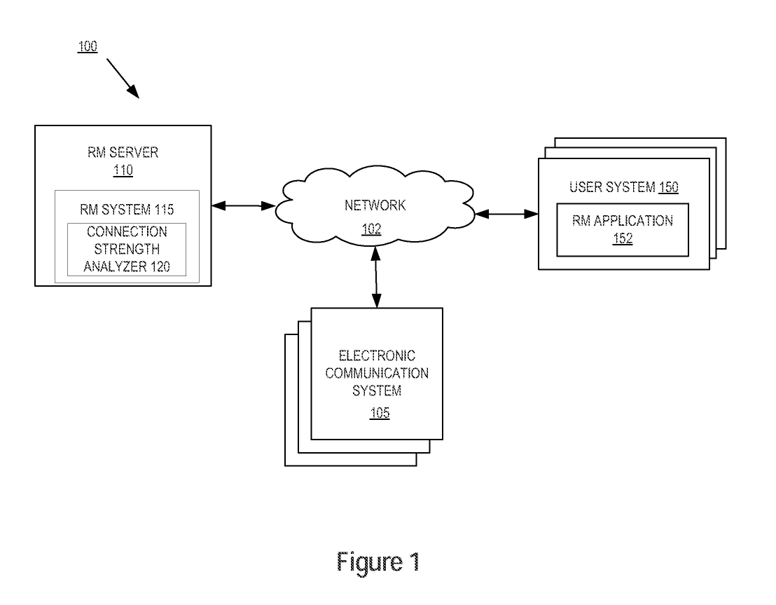

FIG. 1 is a block diagram of exemplary system architecture 100 for determining connection strength determination in a relationship management system in accordance with an embodiment of the invention.

In one embodiment, the system 100 includes a plurality of user systems, such as user system 150, relationship management server 110, and a plurality of electronic communication systems 105. In one embodiment, each user system may be a personal computing device, such as a desktop computer, laptop computer, tablet computer, mobile telephone, personal digital assistant, etc. The relationship management server 110 and electronic communication systems 105 may also be computing devices, such as server computers, desktop computers, etc. The user systems 150, relationship management server 110, and electronic communication systems 105 may be coupled to a network 102 and communicate with one another using any of the standard protocols for the exchange of information.

In one embodiment, one or more of the user systems 150, relationship management server 110, and the plurality of electronic communication systems 105 may run on one Local Area Network (LAN) and may be incorporated into the same physical or logical system, or different physical or logical systems. Alternatively, the user systems 150, relationship management server 110, and the plurality of electronic communication systems 105 may reside on different LANs, wide area networks, cellular telephone networks, etc. that may be coupled together via the Internet but separated by firewalls, routers, and/or other network devices. In yet another configuration, the relationship management server 110 and one or more of the electronic communication systems 105 may reside on the same server, or different servers, coupled to other devices via a public network (e.g., the Internet) or a private network (e.g., LAN). It should be noted that various other network configurations can be used including, for example, hosted configurations, distributed configurations, centralized configurations, etc.

In embodiments discussed herein, relationship management server 110 includes a relationship management system 115. In one embodiment, relationship management as provided by relationship management system 115 involves the capture, analysis, and reporting of communications from electronic communication systems 105 between a single user, or multiple users, within an organization, and various contacts outside of the organization. When a user engages in communication, in concert with a group of users, from an organization, those users are said to be collaborators. Furthermore, when the user and/or collaborators engage in communication with contacts outside the organization for a specific purpose (e.g., sales, business, recruiting, funding, etc.), a relationship is formed. These communications, between relationships and collaborators, may be part of a series of sequential communication and action stages of a process, such as stages of a sales process (e.g., first contact, product demo, price quote, offer, close), a business development process (e.g., growth identification, partner identification, project assignment, growth tracking), a recruiting process (e.g., candidate contact, resume obtained, initial interview, follow-up interview, offer or decline), as well as other processes which are, or can, be carried out with electronic communications. These communications, once identified as belonging to one or more processes, may then be viewed by users and collaborators involved in the particular process. Furthermore, reports may be generated which summarize, provide different visualizations, show progression within a process, and provide feedback on the progression within a process.

In one embodiment, each user system 150 includes a relationship management application 152, which may be an application presented to a user via a web interface, a stand-alone application installed on user systems 150, a mobile application installed on user system 150, or a combination of application types. In one embodiment, relationship management application 152 is a user application that enables a user to interact with the relationship management system 115. In one embodiment, the relationship management system 115 automatically performs various relationship management tasks, such as obtaining electronic communications from electronic communication systems 105, tracking those communications within a process managed by relationship management system 115, automatically generating suggestions for users and collaborators in response to communications from a process, suggesting team members to add as new collaborators to a process, suggesting external contacts to add as relationships to a process, etc., as set forth in U.S. patent application Ser. No. 14/050,125, filed Oct. 9, 2013, and entitled “SYSTEMS AND METHODS FOR AUTOMATIC GENERATION OF A RELATIONSHIP MANAGEMENT SYSTEM,” and as set forth in U.S. patent application Ser. No. 14/080,076, filed Nov. 14, 2013, and entitled “SYSTEMS AND METHODS FOR AUTOMATIC SUGGESTIONS IN A RELATIONSHIP MANAGEMENT SYSTEM,” which are both incorporated into the present application in their entirety.

Relationship management application 152 may then be used by a user to interact with the relationship management system 115 of relationship management server 120. The relationship management system 115, in embodiments discussed herein, generates reports responsive to requests of the relationship management application 152, provides contact information lists for display to a user of relationship management application 152, illustrates various processes associated with a user and the communications between relationships and collaborators within the process in a user interface of relationship management application 152, and provides additional relationship intelligence information obtained from culled electronic communications, such as latest communication, time since last communication, number of total communications, direction of communication, who contacted a relationship within a process, whether a communication is relevant to a process, which team member should follow up with a relationship, etc.

In one embodiment, relationship management system 115 includes connection strength analyzer 120. Connection strength analyzer, as will be discussed in greater detail below, is responsible to determining which users and collaborators within an organization are most strongly connected with contacts outside of an organization. For example, a user in a sales department may desire an introduction to a corporation, but does not have a contact within that organization. In one embodiment, connection strength analyzer 120 utilizes the electronic communication gathering of relationship management system 115 to determine how closely organizational users are connected to non-organizational users. As will be discussed in greater detail below, the closeness of a connection may be based on various factors such as the number of communications exchanged between an organizational user and a non-organizational contact, the quality of those communications, contextual information that may be determined from the content of the communications, etc.

When relationship management application 152 requests connection strengths between non-organizational contacts and one or more organizational users, connection strength analyzer 120 is responsible for generating connection strength results. In one embodiment, the connection strength results may include a subset of one or more organizational users that are determined to have a strong connection with a specific non-organizational user, a specific relationship management account, a specific corporation, etc. In one embodiment, factors such as length of communication exchanged, time since last communication, who initiates communications, length of communication, tone within the communications, total number of communications exchanged, as well as other factors discussed below, are utilized by connection strength analyzer 120 to determine the requested connection strengths between organizational users and the target of the connection strength request. In one embodiment, the connection strength results, which include a ranked or ordered subset of organizational users that are determined to have the strongest connection to the requested target, are then returned to relationship management application 152 for display to the requesting user.

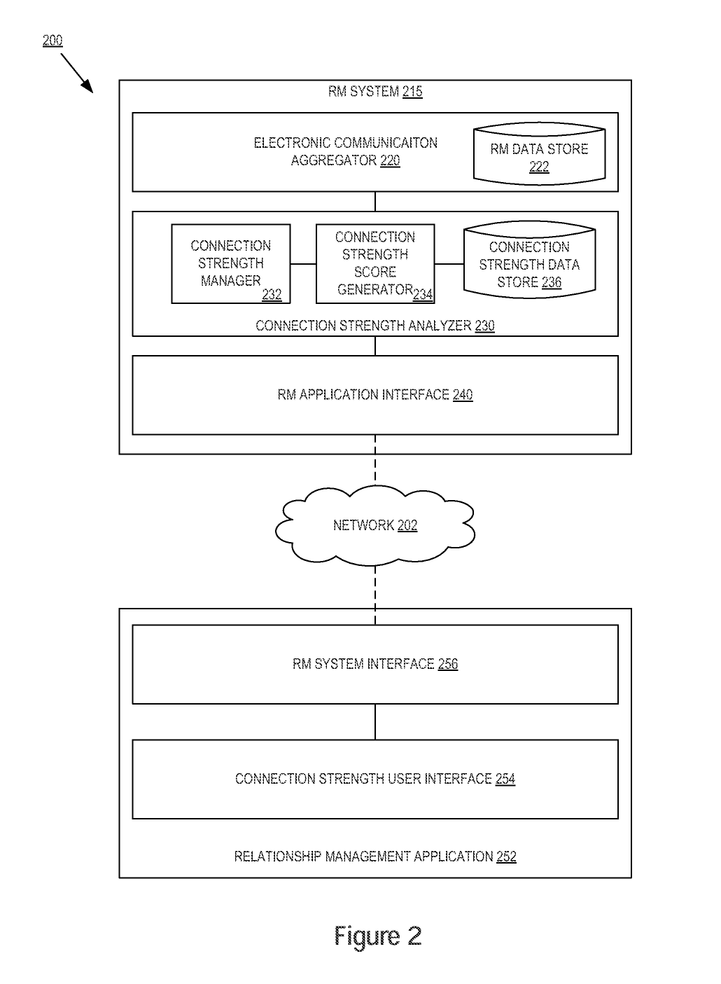

FIG. 2 is a block diagram of one embodiment 200 of a relationship management application 252 and a relationship management system 215. Relationship management application 252 and a relationship management system 215 provide additional details for relationship management application 152 and a relationship management system 115 discussed above in FIG. 1.

In one embodiment, relationship management application 252 includes a relationship management system interface 256 and connection strength user interface 254. In one embodiment, connection strength user interface 254 may be a stand-alone interface/application. In another embodiment, connection strength user interface 254 may be integrated into a comprehensive end-user relationship management application. Relationship management system 115 includes a relationship management application interface 240, connection strength analyzer 230, and an electronic communication aggregator 220. In one embodiment, the relationship management application 252 and a relationship management system 115 communicate with each other via relationship management application interface 240 and relationship management system interface 256 over a network 202. Network 202 may be formed by one or more networks, and may include various network configurations, as discussed above in FIG. 1.

In the relationship management system 215, connection strength analyzer is responsible for determining connection strength scores between organizational users (i.e., users of a relationship management system within an organization) and a specific non-organizational user or a specific group of non-organizational users, such as contacts associated with a relationship management account. Prior to connection strength analyzer 230 determining connection strength scores, electronic communication aggregator 220 obtains electronic communications associated with relationship management system users from one or more electronic communication systems (e.g., electronic communication systems 105). In one embodiment, electronic communication aggregator 220 of relationship management system 215 culls and ingests electronic communications from the various sources associated with the users of the relationship management system 215. In embodiment, relationship management data store 222 maintains a collection of relationship management system users, associated electronic communication systems, and authorizations (e.g., open standard authorization credentials, passwords, etc.) to those communication systems. In one embodiment, electronic communication aggregator 220 accesses the electronic communication systems, utilizing the relationship management system user access credentials, to obtain electronic communications between the user and existing relationship management contacts. For example, electronic communication aggregator 200 utilizes access credentials to access new and existing email messages on one or more email provider systems (not shown), such as the GMAIL™, EXCHANGE™, etc., to access new and existing electronic communications on social network system (not shown), such as FACEBOOK™, TWITTER™, LINKEDIN™, etc., to access voice over internet protocol (VOIP) system communication records, to access cellular telephone system records, to access video conferencing system records, as well as other existing electronic communications and/or records at the specified electronic messaging systems. The electronic communications may be analyzed by relationship management system 215, and data associated with the communications stored in relationship management data store 222.

In one embodiment, electronic communication aggregator 220 periodically queries the different electronic communications systems associated with each of the registered relationship management system 215 users in order to obtain the most recent electronic communications. In one embodiment, as these communications are obtained, connection strength analyzer 230 performs ongoing analysis of those communications to update connection strength scores, as discussed below.

In one embodiment, connection strength analyzer 230 includes a connection strength manager 232, connection strength score generator 234, and connection strength data store 236. In one embodiment, connection strength data store 236 may be integrated into relationship management data store 222. Connection strength manager 232 is responsible for interacting with connection strength user interface 254. The interactions can include receiving relationship management system user requests to opt into connection strength scoring. That is, in order for user communications to be collected, analyzed, and scored for connection strength, a user must first opt-into the scoring system. In one embodiment, the opting-in may include a user of connection strength user interface 254 specifying one or more address books of non-organizational contacts or relationships on which connection score processes may be performed. For example, a user may have a personal address book filled with personal contacts, as well as a business address book filled with business contacts. In one embodiment, the user's opt-in selection may specify to connection strength manager 232 that only those contacts in the business address book, and thus the communications exchanged between the user and the contacts identified in that address book, may be tracked for connection strength scoring purposes. In one embodiment, the shared address space is a subset of all addresses maintained by the relationship management system 215.

In one embodiment, connection strength manager 232 receives the opt-in selection from users as to various address books, or individual addresses, which may be utilized in connection strength analysis, and forms the shared address space. In one embodiment, the shared address space, or data indicative of the shared address space, is stored in connection strength data store 236, and identifies non-organizational users that are associated with at least one user opt-in request. That is, in one embodiment, a non-organizational contact may be included in the shared address space as long as the non-organizational contact is present in at least one organizational user's opt-in preferences. As a result, although a first user may choose not to include an external contact for communication strength scoring purposes, a second use may choose the external contact. Then, the relationship management system would track, for connection strength scoring purposes, the communications between both the first user and the second user with the non-organizational contact in the shared address space. In one embodiment, as long as a non-organizational contact/user is specified in at least one relationship management system 215 user's, and thus a part of the shared address space, all organizational communications with the non-organizational contact are processed for connection strength scoring.

As discussed above, electronic communication aggregator 220 periodically obtains electronic communications for relationship management system users. Connection strength score generator 234 accesses those communications from relationship management data store 222 to determine connection strength scores between non-organizational users in the shared address space and organizational/relationship management system 215 users. In one embodiment, connection strength score generator 234 determines a plurality of static factors associated with each communication, such as whether a communication is directed to an internal contact or an external contact, a frequency of communication between a relationship management system user and a contact in the shared address space, an event type for the communication (e.g., a phone call, meeting, email, etc.), a direction of the communication, a length of the communication, time between communications, whether a relationship management system user and the contact from the shared contacts space are currently participating in a relationship management process, whether a communication belongs to a relationship management process, etc. In one embodiment, connection strength score generator 234 further determines a plurality of intelligence factors, utilizing machine learning model analysis of the content of the communication, as set forth in U.S. patent application Ser. No. 14/050,125, filed Oct. 9, 2013, and entitled “SYSTEMS AND METHODS FOR AUTOMATIC GENERATION OF A RELATIONSHIP MANAGEMENT SYSTEM,” and as set forth in U.S. patent application Ser. No. 14/080,076, filed Nov. 14, 2013, and entitled “SYSTEMS AND METHODS FOR AUTOMATIC SUGGESTIONS IN A RELATIONSHIP MANAGEMENT SYSTEM,” which are both incorporated into the present application in their entirety, to determine a sentiment of a message (e.g., is the sentiment happy, sad, angry, positive, etc.), to determine a category of the message and contact (e.g., closing a deal, making an offer, discussing software specification, etc. used to infer the contact is a deal close, deal maker, engineer/technical expert, etc.), to extract a contact importance from the message (e.g., extract a title to determine a contact is the corporate CEO and not the corporate receptionist), to infer closeness of connection from length of a text portion of a communication (e.g., longer communications imply less familiarity between a relationship management user and an external contact, whereas shorter communications imply greater familiarity), as well as other contextually relevant intelligence factors. In one embodiment, connection strength analyzer 234 stores the static and intelligence factors in connection strength data store 236.

Connection strength score analyzer 234 may then calculate connection strength scores based on one or more of the collected factors. In one embodiment, the connection strength scores are calculated periodically in response to communication gathering of electronic communication aggregator 220. The connection strength scores may be a sum of the various determined factors. In one embodiment, the sum may be weighted based on a relative importance of the various factors. For example, in determining a connection strength score, more recent communications and associated factors could be weighted higher in a connection strength score. As another example, the intelligence factors may have a significant impact on connection strength scoring. For example, communications with a “deal maker,” communications for which a particular sentiment was extracted, communications determined to be related to important matters, etc. could be weighted higher than other communications. As discussed herein, the resulting communication strength scores provide an indication as to how closely a relationship management system user is connected with an external contact, as determined from the static and intelligence factors. Connection strength score generator stores the scores in connection strength data store 236.

In one embodiment, connection strength user interface 254 receives user request for organizational/relationship management system users that have strong connections with a specific non-organizational contact or a specific relationship management system 215 account (i.e., a collection of non-organizational contacts that are all associated with an external organization or entity). The requests are transferred via interface 256 to connection strength manager 232. Connection strength score manager 232 request a listing of the most closely connected organizational users from connection strength score generator 234. Connection strength score generator 234 accesses the previously calculated scores in connection strength data store 236 to select a subset of relationship management system users that have the highest connection strength scores corresponding to the request. The listing of organizational users, which are most closely connected to the requested specific non-organizational contact or a specific relationship management system 215 account are then provided to relationship management application 252 for display to a user in interface 254.

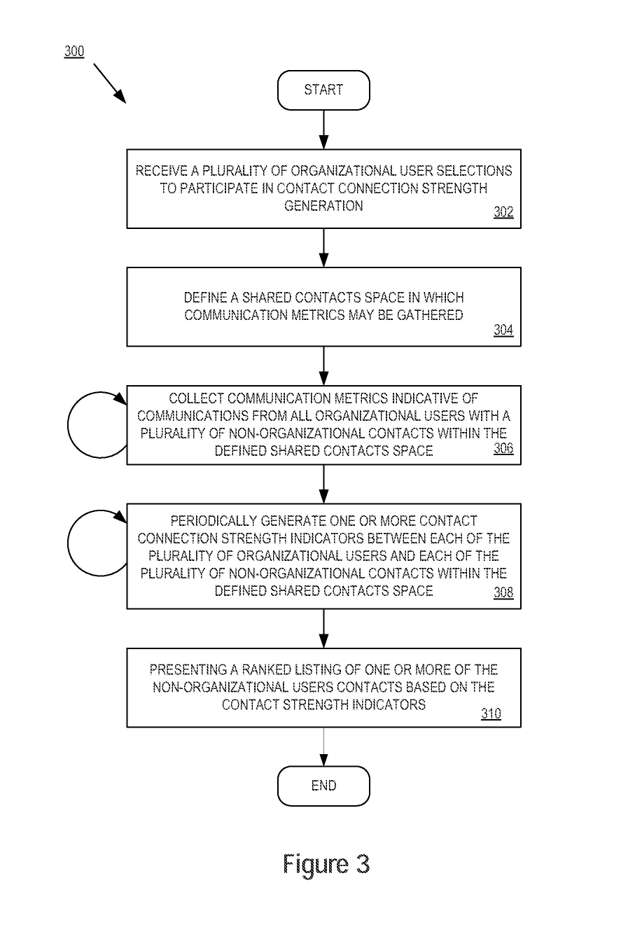

FIG. 3 is a flow diagram of one embodiment of a method for gathering connection strength data in a shared contacts space of a relationship management system. The method 300 is performed by processing logic that may comprise hardware (circuitry, dedicated logic, etc.), software (such as is run on a general purpose computer system or a dedicated machine), firmware, or a combination. In one embodiment, the method 300 is performed by a relationship management system, such as relationship management system 115 or 215.

Referring to FIG. 3, processing logic begins by receiving a plurality of organizational user selections to participate in contact connection strength generation (processing block 302). In one embodiment, the organizational users are users of a relationship management system from the organization. Furthermore, as discussed above, the opting in, or selection to participate in contact connection strength generation, includes the specification of at least one electronic address book. The electronic address book defines contacts outside of the organization or relationship management system to include in the subsequent contact connection strength generation discussed below.

Processing logic then defines a shared contacts space in which communications metrics may be gathered (processing block 304) and periodically collects communication metrics indicative of communications from all organizational users with the plurality of non-organizational contacts within the defined shared address space (processing block 306). In one embodiment, the communication metrics may include the static and intelligence factors relevant to connection strength determination discussed above. Furthermore, as long as at least one organizational user specified an external contact during processing block 302, metrics may be gathered for all organizational users' communication with the external contact in the shared address space, including a user who chose not to place a contact in the shared address space. For example, if John opts-into contact connection strength generation and selects an address book which excludes Alice, but Jane opts-into contact connection strength generation and selects an address book which includes Alice, all communications between Alice and John, and Alice and Jane, will be subject to communication metric gathering.

Processing logic periodically generates one or more contact connection strength indicators between each of the plurality of organizational users and each of the plurality of non-organizational contacts within the defined shared contacts space (processing block 308). In one embodiment, the contact connection strength indicators may include connection strength scores between an organizational users and a non-organizational contact in the shared contacts space. In one embodiment, the scores may be generated in response to the collection of communication metrics in processing block 306, at predefined periodic intervals, or in response to user requests. Furthermore, the scores may be generated based on a sum of the various metrics, where each metric is weighted according to one or more importance factors. For example, an intelligence metric that indicates the tone of a message as positive may lead to greater weighting for that factor, as well as an adjustment to one or more static factors. For example, if the static metric of a number of messages exchanged between an organizational user and a contact is subject to an initial connection strength score, that initial score may be increased, decreased, weighted, etc. based on a related intelligence factor, such as message sentiment during the message exchange.

Processing logic may then present a ranked list of one or more organizational users that have the highest score for a non-organizational contact based on the contact strength indicators (processing block 310). In one embodiment, the ranked list is presented in a user interface in response to a user request for a contact connection strength recommendation. In one embodiment, the presentation may include one or more visual indicators of the factors used for determining the scoring and selection of the organizational users.

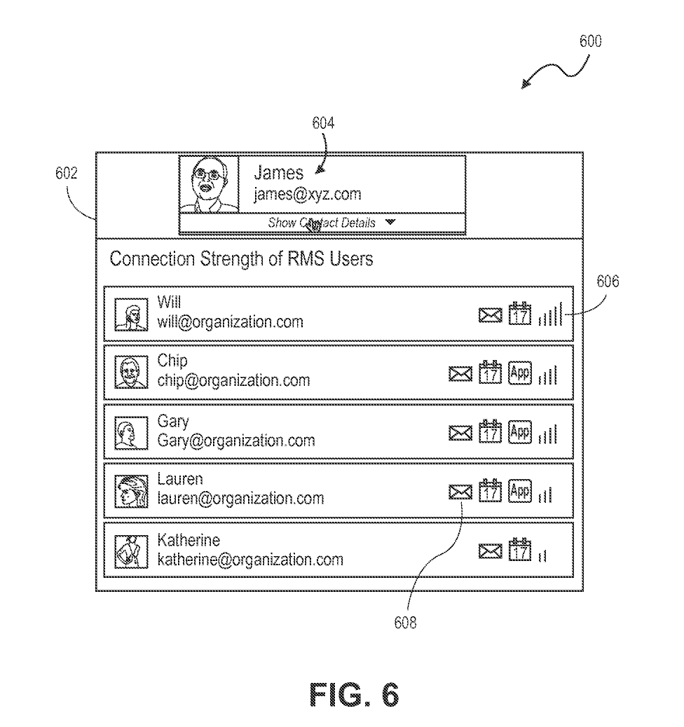

FIG. 6 illustrates an exemplary user interface 600 for presenting a subset of organizational users 602 that are determined to be closely connected with a specific non-organizational contact 604. In the embodiment illustrated in FIG. 6, the subset 602 may be ordered based on relative connections strengths from the organizational user with the highest relative connection strength score to contact 604, to the user with the lowest connection strength score to contact 604. In one embodiment, to further indicate the relative connection strengths between organizational users 602 and the non-organizational contact 604, the presentation of the subset of organizational users 602 may graphically indicate the relative ranking 606. In one embodiment, the relative connections strength scores may be rendered as a signal strengths of varying degrees. Furthermore, the presentation of the subset may include the communication channels 608 that were most relevant in determining a specific organizational user's connection strength score.

In one embodiment, organizational users with a strong connection to a selected non-organizational contact may be presented to a user. However, often the user will be interested in a set of contacts, such as contacts in a relationship management system account. The relationship management system account may be defined for a specific entity (e.g., a corporation), and include a set of contacts associated with the account (e.g., non-organizational contacts from the corporation). Organizational user requests for contact connection strength rankings to an account, such as “who is most closely connected with XYZ Corp.,” is discussed below.

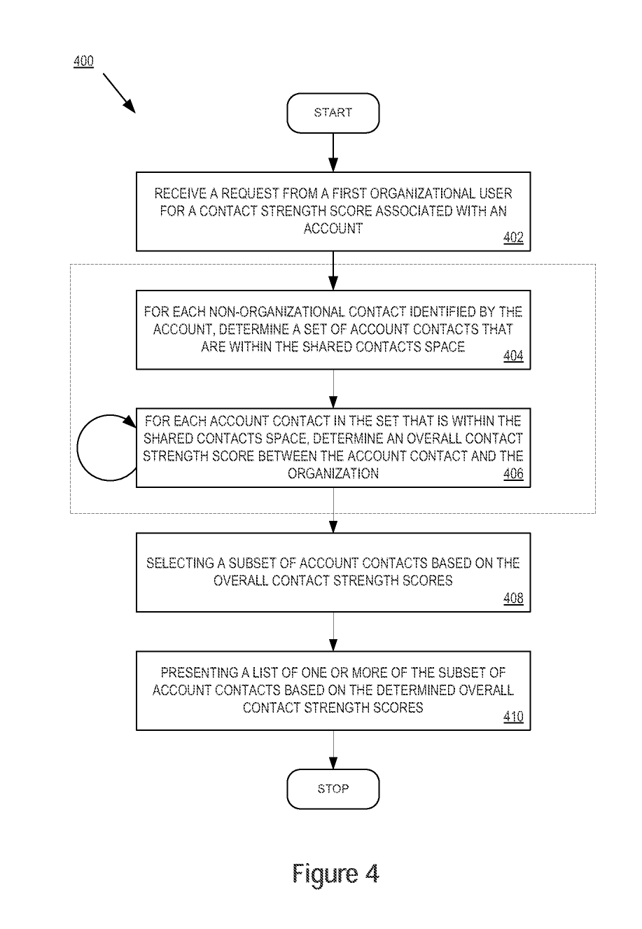

FIG. 4 is a flow diagram of one embodiment of a method for determining contacts within an account in a relationship management system that are closely connected to an organization. The method 400 is performed by processing logic that may comprise hardware (circuitry, dedicated logic, etc.), software (such as is run on a general purpose computer system or a dedicated machine), firmware, or a combination. In one embodiment, the method 400 is performed by a relationship management system, such as relationship management system 115 or 215.

Processing logic begins by receiving a request from a first organizational user for a contact strength score associated with an account (processing block 402). In one embodiment, the first organizational user is a user of a relationship management system, and the account includes a collection of non-organizational contacts associated with an entity, corporation, etc. in the relationship management system. For example, the relationship management system may have accounts for SoftwareCorp and HardwareCorp, and maintain contact listings for all non-organizational contacts associated with each account.

For each non-organizational contact identified by the account, processing logic determines a set of account contacts that are within the shared address space (processing block 404). For each account contact in the set that is within the shared address space, processing logic determines an overall contact strength score between the account contact and the organization (processing block 406). In one embodiment, the overall contact strength score is determined for each non-organizational account contact that is also within the shared address space. In one embodiment, the overall contact strength score is the sum of individual contact strength scores between the non-organizational contact and all of the relationship management system users. For example, if Alice is listed in an account and communicates with John and Jane, who are both from an organization, then Alice's overall contact strength score would be the sum Alice's contact strength score for communications with John and Alice's contact strength score for communications with Jane.

In one embodiment, processing blocks 404 and 406 are illustrated in dashed line because the overall contact strength score may be pre-generated prior to receipt of the request at processing block 402. For example, at a time of the periodic communication gathering and metric determination discussed above in FIG. 3, the overall contact strength scores for contacts associated with accounts of a relationship management system may be determined and stored in a database (e.g., data store 236). Then, in response to the request at processing block 402, the overall contact scores could quickly be obtained from the database.

In either embodiment, after the overall contact strength scores for account members has been obtained, processing logic selects a subset of account contacts based on the overall contact strength scores (processing block 408). For example, processing logic may select the five account contacts that have the highest scores.

In one embodiment, intelligence factors may be utilized for specification of account contact strength requests and when selecting account contacts. For example, the request received at processing block 402 specify that an account contact strength score is requested, but that the score should be generated for “deal makers” or other categories/types of non-organizational contacts. The contact type intelligence factor, which is determined from the contents and context of communications as discussed above, may then be utilized by processing logic to adjust an overall contact strength score for account contacts of the specified type. Furthermore, account contacts not of the specified type may be excluded from the subset selection. For example, a relationship management system user may request contact strength scores for the “deal makers” from SoftwareCorp. From the communications exchanged between Alice and Andy of SoftwareCorp with relationship management system users, intelligence factors may indicate that Alice is a highly placed sales executive that often signs and commits to contracts, whereas Andy is often involved in technical communication. From the intelligence factors, which indicate Alice is likely a “deal maker,” whereas Andy is likely not, the overall contact strength score of Alice could be provided an additional weighting, Andy's score excluded from selection, etc.

After the subset is selected, processing logic optionally presents a listing of one or more of the subset of account contacts based on the determined overall contact strength scores (processing block 410). In one embodiment, the presented listing indicates which non-organizational contacts from an account are most closely connected with the organization. Continuing the example above, Alice and Andy may be presented as the most closely related contacts to the users of a relationship management system from among a plurality of contacts associated with the account for SoftwareCorp. As will be discussed below, it is subsequently determined for the closely connected non-organizational contacts, which organizational users are most closely connected with them.

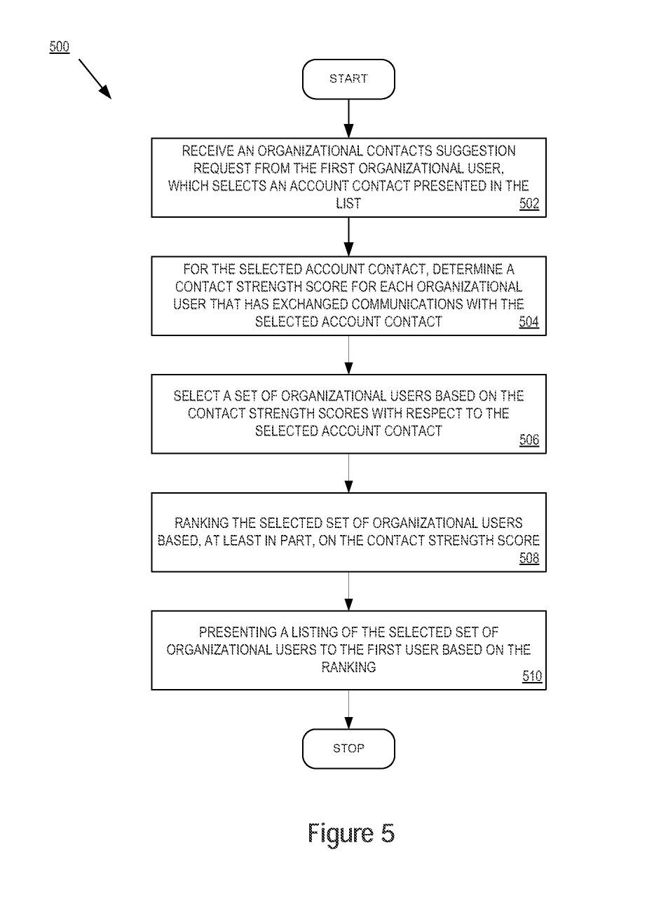

FIG. 5 is a flow diagram of one embodiment of a method for determining which organizational users are closely connected with a subset of closely connected account contacts. The method 500 is performed by processing logic that may comprise hardware (circuitry, dedicated logic, etc.), software (such as is run on a general purpose computer system or a dedicated machine), firmware, or a combination. In one embodiment, the method 400 is performed by a relationship management system, such as relationship management system 115 or 215.

Processing logic begins by receiving an organizational user suggestion request from the first organizational user, which selects an account contact presented in the list (processing block 502). In one embodiment, the request identifies an account contact presented in the listing generated at processing block 410 above. For the selected account contact, processing logic determines a contact strength score for each organizational user that has exchanged communications with the selected account contact (processing block 504). In one embodiment, processing logic access the contact strength scores for the organizational users in a connection strength data store, as generated above in FIGS. 2 and 3.

Processing logic then selects a set of organizational users based on the contact strength scores with respect to the selected account contact (processing block 506). The selected organizational users may then be ranked relative to one another based, at least in part, on the contact strength scores (processing block 508). As discussed herein, the contract strength scores are based on a weighted sum of various communication activity factors for communications exchanged between specific organizational users and specific non-organizational contacts. However, other intelligence factors and/or criteria specified in a user's request (such as restriction to “deal makers”, “technical personal”, etc.) may have an impact on the ranking of the selected set of organizational users.

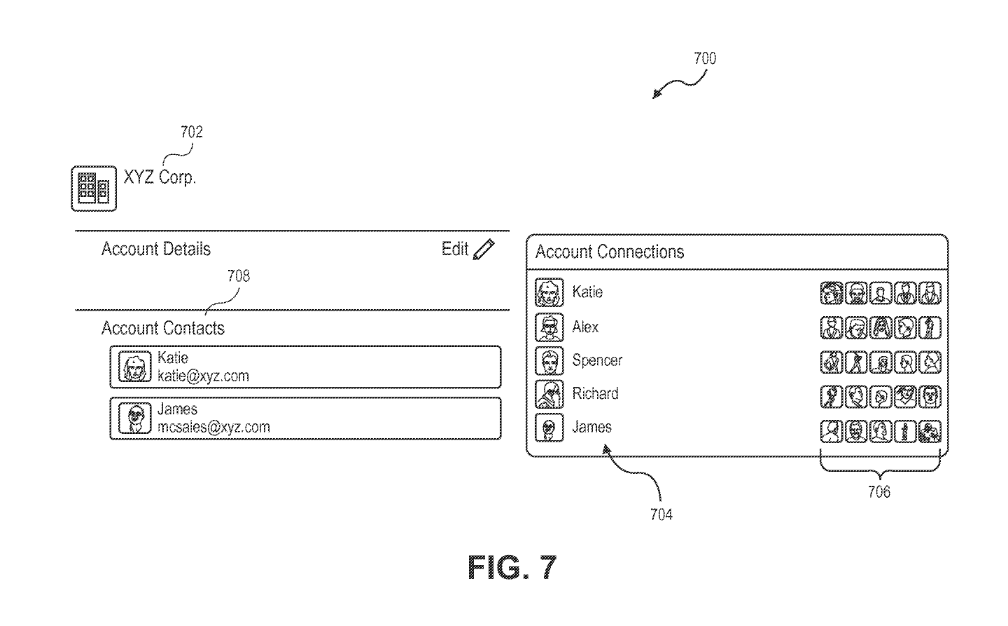

The listing of the selected set of organizational users is then presented to the first user based on the ranking (processing block 510). FIG. 7 illustrates an exemplary user interface 700 for presenting connection strength determinations between an account and users of a relationship management system. For a specified account 702 with a set of account contacts 708, after the subset of account contacts is selected as discussed in FIG. 4, the subset is displayed 704 to the user. Furthermore, specific organizational users 706 of the relationship management system may then be selected and displayed as being closely connected to each of the account contacts. In one embodiment, as discussed in FIG. 5, the organizational users 706 are displayed based on their relative ranking of closeness with the corresponding account contacts 704.

Although processing blocks 504-510 were discussed within the context of a selected account contact, in one embodiment, the processes of blocks 504-510 may be performed for each listed account contact automatically. Then, an indication of a ranking of organizational users for each account contact may be provided to a user as illustrated in FIG. 7.

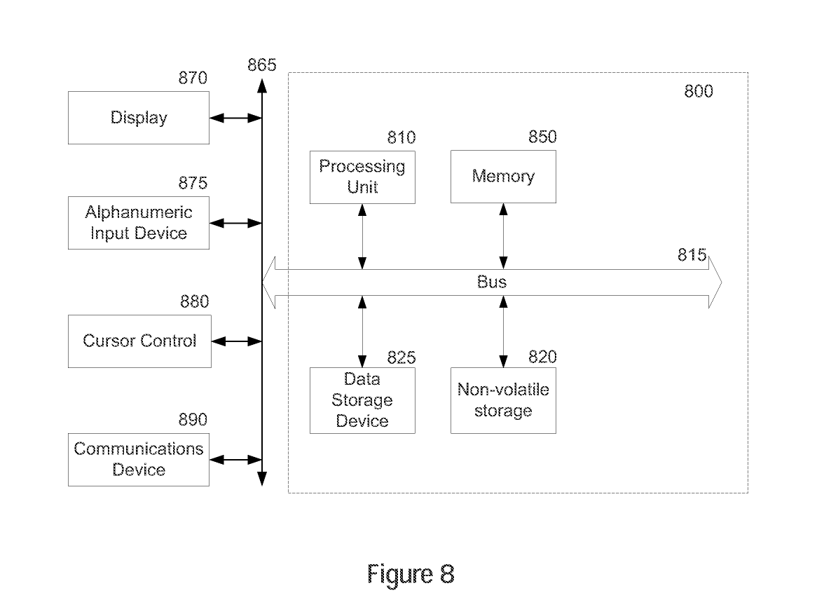

FIG. 8 is one embodiment of a computer system that may be used with the present invention. It will be apparent to those of ordinary skill in the art, however that other alternative systems of various system architectures may also be used.

The data processing system illustrated in FIG. 8 includes a bus or other internal communication means 815 for communicating information, and a processor 810 coupled to the bus 815 for processing information. The system further comprises a random access memory (RAM) or other volatile storage device 850 (referred to as memory), coupled to bus 815 for storing information and instructions to be executed by processor 810. Main memory 850 also may be used for storing temporary variables or other intermediate information during execution of instructions by processor 810. The system also comprises a read only memory (ROM) and/or static storage device 820 coupled to bus 815 for storing static information and instructions for processor 810, and a data storage device 825 such as a magnetic disk or optical disk and its corresponding disk drive. Data storage device 825 is coupled to bus 815 for storing information and instructions.

The system may further be coupled to a display device 870, such as a cathode ray tube (CRT) or a liquid crystal display (LCD) coupled to bus 815 through bus 865 for displaying information to a computer user. An alphanumeric input device 875, including alphanumeric and other keys, may also be coupled to bus 815 through bus 865 for communicating information and command selections to processor 810. An additional user input device is cursor control device 880, such as a touchpad, mouse, a trackball, stylus, or cursor direction keys coupled to bus 815 through bus 865 for communicating direction information and command selections to processor 810, and for controlling cursor movement on display device 870.

Another device, which may optionally be coupled to computer system 800, is a communication device 890 for accessing other nodes of a distributed system via a network. The communication device 890 may include any of a number of commercially available networking peripheral devices such as those used for coupling to an Ethernet, token ring, Internet, or wide area network. The communication device 890 may further be a null-modem connection, or any other mechanism that provides connectivity between the computer system 800 and the outside world. Note that any or all of the components of this system illustrated in FIG. 8 and associated hardware may be used in various embodiments of the present invention.

It will be appreciated by those of ordinary skill in the art that any configuration of the system may be used for various purposes according to the particular implementation. The control logic or software implementing the present invention can be stored in main memory 850, mass storage device 825, or other storage medium locally or remotely accessible to processor 810.

It will be apparent to those of ordinary skill in the art that the system, method, and process described herein can be implemented as software stored in main memory 850 or read only memory 820 and executed by processor 810. This control logic or software may also be resident on an article of manufacture comprising a computer readable medium having computer readable program code embodied therein and being readable by the mass storage device 825 and for causing the processor 810 to operate in accordance with the methods and teachings herein.

The present invention may also be embodied in a handheld or portable device containing a subset of the computer hardware components described above. For example, the handheld device may be configured to contain only the bus 815, the processor 810, and memory 850 and/or 825. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

The present invention may also be embodied in a special purpose appliance including a subset of the computer hardware components described above. For example, the appliance may include a processor 810, a data storage device 825, a bus 815, and memory 850, and only rudimentary communications mechanisms, such as a small touch-screen that permits the user to communicate in a basic manner with the device. In general, the more special-purpose the device is, the fewer of the elements need be present for the device to function.

In one embodiment, the access to electronic communications, tracking of communications, and extraction of contact, collaborator, and relationship data from the electronic communications is predicated on privacy controls maintained by a relationship management server. The privacy controls enable users to select what data should be shared with participants (i.e., relationships and collaborators) within a process, what data should be tracked, what data from one user can be shared, displayed, or used by a second user, etc. In one embodiment, these privacy controls may initially be set to a maximum degree of privacy, such that no data is shared, obtained, or tracked. A user may then opt-into one or more of the data acquisition, tracking, and sharing processes discussed herein.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

We claim:

1. A computer-implemented method, comprising:
receiving a request from a first user of a relationship management system user for a connection strength score associated with a relationship management system account, wherein the relationship management system is associated with an organization and the account comprises a plurality of contacts for users that are associated with a different organization;
determining, by a computer processing system, connection strength scores between each of the plurality of contacts in the account and the organization based on communications exchanged between each of the plurality of contacts with users of the relationship management system;
selecting a subset of contacts from the account based on the determined connection strength scores; and
presenting the selected subset of contacts from the account to the first relationship management system user.

2. The method of claim 1, wherein a determined connection strength score for an account contact is an overall connection strength score, further comprising:
determining individual connection strength scores between the account contact and each of the users of the relationship management system; and
generating the overall connection strength score based, at least in part, on a sum of the individual connection strength scores.

3. The method of claim 2, wherein generating an individual connection strength score between the account contact and a relationship management system user comprises:
collecting communication metrics indicative of communications exchanged between the account contact and the relationship management system user, each communication metric having a connection strength score value; and
generating the individual connection strength score based on a combination of connection strength score values.

4. The method of claim 3, wherein the communication metrics comprise intelligence connection strength factors determined from machine learning model analysis of content of communications, the intelligence connection strength factors including one or more of a sentiment of contents of communications, a category of communications, an importance of the account contact as determined from contents of communications, and a length of communications.

5. The method of claim 4, wherein the communication metrics comprise static connection strength factors including one or more of a number of communications exchanged, a frequency of communications exchanged, a direction of communications, a latency of response communications, an event type associated with communications, and whether the communication is occurring within a relationship management system process.

6. The method of claim 5, wherein presence of an intelligence connection strength factor in a communication adjust one or more connection strength score values associated with static connection strength factors.

7. The method of claim 3, wherein collection of communication metrics further comprises:
receiving opt-in requests from a plurality of relationship management system users, where each opt-in request specifies an address book of contacts that are not users of the relationship management system;
combining the contacts identified in address books in the received opt-in requests to form a shared address space of the relationship management system, wherein the shared address space is a subset of all contacts managed by the relationship management system; and
performing communication metrics collection and individual connection strength score generation only for contacts located within the share address space of the relationship management system.

8. The method of claim 7, wherein communication metrics are collected and an individual connection strength score is generated for communications between an account contact and the first user of the relationship management system user when a second user of the relationship management system included the account contact in an opt-in request, and the first user of the relationship management system did not include the account contact in an opt-in request.

9. The method of claim 2, wherein presenting the selected subset of contacts from the account to the first relationship management system user further comprises for each account contact in the selected subset:
determining individual connection strength scores between said each account contact and each relationship management system user that has exchanged one or more communications with said each account contact;
selecting a subset of relationship management system users based on their relative individual connection strength scores for said each account contact; and
presenting the selected subset of relationship management system users in an order based, at least in part, on the relative individual connection strength scores.

10. A non-transitory computer readable storage medium including instructions that, when executed by a processor, cause the processor to perform a method comprising:
receiving a request from a first user of a relationship management system user for a connection strength score associated with a relationship management system account, wherein the relationship management system is associated with an organization and the account comprises a plurality of contacts for users that are associated with a different organization;
determining connection strength scores between each of the plurality of contacts in the account and the organization based on communications exchanged between each of the plurality of contacts with users of the relationship management system;
selecting a subset of contacts from the account based on the determined connection strength scores; and
presenting the selected subset of contacts from the account to the first relationship management system user.

11. The non-transitory computer readable storage medium of claim 10, wherein a determined connection strength score for an account contact is an overall connection strength score, further comprising:
determining individual connection strength scores between the account contact and each of the users of the relationship management system; and
generating the overall connection strength score based, at least in part, on a sum of the individual connection strength scores.

12. The non-transitory computer readable storage medium of claim 11, wherein generating an individual connection strength score between the account contact and a relationship management system user comprises:
collecting communication metrics indicative of communications exchanged between the account contact and the relationship management system user, each communication metric having a connection strength score value; and
generating the individual connection strength score based on a combination of connection strength score values.

13. The non-transitory computer readable storage medium of claim 12, wherein the communication metrics comprise intelligence connection strength factors determined from machine learning model analysis of content of communications, the intelligence connection strength factors including one or more of a sentiment of contents of communications, a category of communications, an importance of the account contact as determined from contents of communications, and a length of communications.

14. The non-transitory computer readable storage medium of claim 13, wherein the communication metrics comprise static connection strength factors including one or more of a number of communications exchanged, a frequency of communications exchanged, a direction of communications, a latency of response communications, an event type associated with communications, and whether the communication is occurring within a relationship management system process,

15. The non-transitory computer readable storage medium of claim 14, wherein presence of an intelligence connection strength factor in a communication adjust one or more connection strength score values associated with static connection strength factors.

16. The non-transitory computer readable storage medium of claim 12, wherein collection of communication metrics further comprises:
receiving opt-in requests from a plurality of relationship management system users, where each opt-in request specifies an address book of contacts that are not users of the relationship management system;
combining the contacts identified in address books in the received opt-in requests to form a shared address space of the relationship management system, wherein the shared address space is a subset of all contacts managed by the relationship management system; and
performing communication metrics collection and individual connection strength score generation only for contacts located within the share address space of the relationship management system.

17. The non-transitory computer readable storage medium of claim 16, wherein communication metrics are collected and an individual connection strength score is generated for communications between an account contact and the first user of the relationship management system user when a second user of the relationship management system included the account contact in an opt-in request, and the first user of the relationship management system did not include the account contact in an opt-in request.

18. The non-transitory computer readable storage medium of claim 11, wherein presenting the selected subset of contacts from the account to the first relationship management system user further comprises for each account contact in the selected subset:
determining individual connection strength scores between said each account contact and each relationship management system user that has exchanged one or more communications with said each account contact;
selecting a subset of relationship management system users based on their relative individual connection strength scores for said each account contact; and
presenting the selected subset of relationship management system users in an order based, at least in part, on the relative individual connection strength scores.

19. A system, comprising:
a memory to store one or more relationship management system databases; and
a processor coupled with the memory to
receive a request from a first user of a relationship management system user for a connection strength score associated with a relationship management system account, wherein the relationship management system is associated with an organization and the account comprises a plurality of contacts for users that are associated with a different organization,
determine connection strength scores between each of the plurality of contacts in the account and the organization based on communications exchanged between each of the plurality of contacts with users of the relationship management system;
select a subset of contacts from the account based on the determined connection strength scores, and
present the selected subset of contacts from the account to the first relationship management system user.

20. The system of claim 19, wherein a determined connection strength score for an account contact is an overall connection strength score, further comprising the processor configured to
determine individual connection strength scores between the account contact and each of the users of the relationship management system, and
generate the overall connection strength score based, at least in part, on a sum of the individual connection strength scores.

21. The system of claim 20, wherein presentation of the selected subset of contacts from the account to the first relationship management system user further comprises the processor configured to, for each account contact in the selected subset,
determine individual connection strength scores between said each account contact and each relationship management system user that has exchanged one or more communications with said each account contact,
select a subset of relationship management system users based on their relative individual connection strength scores for said each account contact, and
present the selected subset of relationship management system users in an order based, at least in part, on the relative individual connection strength scores.
